(19) United States
(12) Patent Application Publication
(10) Pub. No.: US 2025/0206612 A1
(43) Pub. Date: Jun. 26, 2025

(54) PROCESS FOR MANUFACTURING BIS(FLUOROSULFONYL)IMIDE SALTS

(71) Applicant: SPECIALTY OPERATIONS FRANCE, Lyon (FR)

(72) Inventors: Elie Derrien, Brignais (FR); Philippe Marion, Vernaison (FR)

(73) Assignee: SPECIALTY OPERATIONS FRANCE, Lyon (FR)

(21) Appl. No.: 18/848,498

(22) PCT Filed: Mar. 13, 2023
(86) PCT No.: PCT/EP2023/056317

§ 371 Date: Sep. 18, 2024

(30) Foreign Application Priority Data
Mar. 18, 2022 (EP) 22305321.6

(51) Int. Cl. C01B 21/093; H01M 10/0568

(52) U.S. Cl. CPC C01B 21/0935; H01M 10/0568; H01M 2300/0025

(57) ABSTRACT

The present invention relates to a process for preparing a salt of bis(fluorosulfonyl)imide, preferably lithium bi(fluorosulfonyl)imide (LiFSI).

### REFERENCE TO RELATED APPLICATION

This application claims priority to earlier European Patent Application filed on 18 Mar. 2022 with Nr 22305321.6, the whole content of this application being incorporated herein by reference for all purposes.

### TECHNICAL FIELD

The present invention relates to a process for preparing a salt of bis(fluorosulfonyl)imide, preferably lithium bi(fluorosulfonyl)imide (LiFSI).

### BACKGROUND

Bis(fluorosulfonyl)imide and salts thereof, in particular the lithium salt of bis(fluorosulfonyl)imide (LiFSI), are useful compounds in a variety of technical fields, including in battery electrolytes.

Several methods and processes for the manufacture of alkali metal salts of bis(fluorosulfonyl)imide are currently under development and have been described in literature and patent documents.

Among the various technologies described, the majority uses a fluorination reaction with a fluorinating agent in a solvent. For example, US 2019/0292054 (Nippon Shokubai Co., Ltd.) discloses a method for producing an alkali metal salt of bis(fluorosulfonyl)imide comprising reacting bis(fluorosulfonyl)imide with an alkali metal compound in a reaction solution containing an organic solvent selected from carbonate solvents, cyclic ether solvents, linear ether solvents having two or more oxygen atoms in the molecule, cyclic ester solvents, sulfolane solvents, N,N-dimethyl formamide, dimethyl sulfoxide and N-methyl oxazolidinone.

EP 3825278 (Shanghai Rolechem Co., Ltd.) discloses a method for preparing a bis(fluorosulfonyl)imide salt starting from bis(fluorosulfonyl)imide and M⁺ₙXⁿ⁻ wherein M is selected from Li, Na, K, Rb and Cs; and X is an anion including at least one element of B, O, N, P and Si, and n being equal to or higher than 2; wherein the two ingredients are mixed into a non-aqueous solvent, reacted and a post-treatment (eg. filtration, vacuum concentration and recrystallization in a poor solvent) is then carried out to obtain the final product.

U.S. Pat. No. 10,505,228 (Synthio Chemicals, LLC.) discloses a method for removing water from a liquid solution comprising a non-aqueous solvent, a hygroscopic metal salt and water. More in particular, the method includes mixing the following ingredients: (i) a liquid solution comprising an acidic form of a hygroscopic alkali metal salt and a first solvent, (ii) an alkali metal base and (iii) an aprotic electrolyte solvent. The resulting mixture produces a vapor that includes water, a first solvent or a combination thereof. The vapor is then removed from the mixture to reduce the amount of water to produce the aprotic electrolyte solution. Alkali metal bases typically include alkali metal carbonate, alkali metal hydroxide, alkali metal bicarbonate or combination thereof. Exemplary lithium bases include lithium hydroxide, lithium carbonate, lithium bicarbonate and combination thereof. Example 3 of U.S. Pat. No. 10,505,228 discloses the reaction between HFSI and lithium carbonate in a large amount of water.

Under the process disclosed in this patent, the neutralization and the distillation or drying steps are disclosed as subsequent steps. As a consequence, the water content in the reaction medium during the process can be relatively high and remain high at the end of the neutralization step, which might generate FSI side-products,. In addition, the overall process requires a long time.

### SUMMARY OF THE INVENTION

The Applicant faced the problem of developing a method for the manufacture of a solution of a high purity salt of bis(fluorosulfonyl)imide characterized by a low water content.

The Applicant also faced the problem of developing a method wherein the formation of FSI side-products may be limited or also avoided, such that a high purity salt of bis(fluorosulfonyl)imide is obtained and the need for post-purification step(s) is limited.

Facing the above technical problem, the Applicant surprisingly developed a method wherein the concentration of water before and during the neutralization step is kept very low, which may limit the formation of undesired FSI side-products.

Also, the method developed by the Applicant is characterized by a low energy consumption, which makes it suitable for industrial application.

Thus, in a first embodiment, the present invention relates to a method for manufacturing a solution [solution (S1)] comprising at least one organic aprotic solvent and at least one bis(fluorosulfonyl)imide.

The inventive method according to the present invention advantageously provides for a solution (S1) in a solvent suitable for non-aqueous electrolyte formulations, whose handling is much easier than the solid form.

### DETAILED DESCRIPTION OF THE INVENTION

In the present application:
the expression “comprised between . . . and . . . ” should be understood as including the limits;
any description, even though described in relation to a specific embodiment, is applicable to and interchangeable with other embodiments of the present invention;
where an element or component is said to be included in and/or selected from a list of recited elements or components, it should be understood that in related embodiments explicitly contemplated here, the element or component can also be any one of the individual recited elements or components, or can also be selected from a group consisting of any two or more of the explicitly listed elements or components; any element or component recited in a list of elements or components may be omitted from such list; and
any recitation herein of numerical ranges by endpoints includes all numbers subsumed within the recited ranges as well as the endpoints of the range and equivalents.

In a first embodiment, the present invention relates to a method for manufacturing a solution [solution (S1)] comprising at least one organic aprotic solvent and at least one bis(fluorosulfonyl)imide salt represented by the following formula (I):

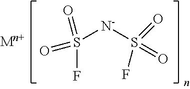

wherein
Mⁿ⁺ represents a metal cation and
n is an integer from 1 to 4;
   said method comprising the following steps:
(A) contacting hydrogen bis(fluorosulfonyl)imide (HFSI), at least one aprotic organic solvent [solvent(S)] and at least one alkali metal compound [compound (AM)], so as to provide a reaction mixture [mixture (M1)], and
(B) removing any water present in said mixture (M1), thus providing said solution (S1);
   wherein steps (A) and (B) are performed simultaneously.

Preferably, said metal cation Mⁿ⁺ is an alkali metal cation, more preferably selected from Na, Li, K, Rb, and Cs. Among these, Li, Na and K are more preferred.

Preferably, said compound (AM) is selected from the group comprising, more preferably consisting of: LiOH, NaOH, KOH, RbOH, CsOH, LiOH·H₂O, NaOH·H₂O, KOH·H₂O, RbOH·H₂O, CsOH·H₂O, Li₂CO₃, Na₂CO₃, K₂CO₃, Rb₂CO₃, Cs₂CO₃, LiHCO₃, NaHCO₃, KHCO₃, RbHCO₃ and CsHCO₃. More preferably, said compound (AM) is selected from the group consisting of LiOH·H₂O, NaOH·H₂O, KOH·H₂O, RbOH·H₂O, CSOH·H₂O, Li₂CO₃, Na₂CO₃, K₂CO₃, Rb₂CO₃ and Cs₂CO₃. Even more preferably, said compound (AM) is selected from the group consisting of: LiOH·H₂O and Li₂CO₃.

Preferably, the amount of said compound (AM) is from about 1.0 mol to about 10 mol more preferably of from 1.0 mol to 5.0 mol, even more preferably of from 1.0 mol to 2.0 mol, and still more preferably from 1.0 mol to 1.5 mol, per 1.0 mol of HFSI.

Preferably, said solvent(S) is selected in the group comprising ethylene carbonate, propylene carbonate, butylene carbonate, γ-butyrolactone, γ-valerolactone, dimethoxymethane, 1,2-dimethoxyethane, tetrahydrofuran, 2-methyltetrahydrofuran, 1,3-dioxane, 4-methyl-1,3-dioxolane, methyl formate, methyl acetate, methyl propionate, dimethyl carbonate, ethyl methyl carbonate, diethyl carbonate, sulfolane, 3-methylsulfolane, dimethylsulfoxide, N,N-dimethylformamide, N-methyl oxazolidinone, acetonitrile, valeronitrile, benzonitrile, ethyl acetate, isopropyl acetate, n-butyl acetate, nitromethane and nitrobenzene. More preferably, said solvent (S) is selected from ethylene carbonate, propylene carbonate, butylene carbonate, tetrahydrofuran, dimethyl carbonate, ethyl methyl carbonate, diethyl carbonate, ethyl acetate, isopropyl acetate and n-butyl acetate, even more preferred solvents include dimethyl carbonate, ethyl methyl carbonate, diethyl carbonate, ethyl acetate, isopropyl acetate and n-butyl acetate. Even more preferably, said solvent (S) is selected from ethyl methyl carbonate and n-butyl acetate.

According to a preferred aspect, said solvent (S) has a water content of 500 ppm or less, preferably of 250 ppm or less, more preferably of 100 ppm or less, and even more preferably of 50 ppm or less.

Advantageously, step (A) and step (B) are performed at the same temperature.

Preferably, steps (A) and (B) can be performed at a temperature from −10° C. to 40° C., 25° C., more preferably from −5° C. to 30° C.

Advantageously, step (A) and step (B) are performed at the same pressure.

Preferably, steps (A) and (B) are performed at a pressure from 1 mbar to 1 bar, more preferably from 5 mbar to 50 mbar, and even more preferably from 10 to 20 mbar.

The reaction time required for steps (A) and (B) is not limited and depends on the reaction scale and on the process conditions. The person skilled in the art will understand how to set the reaction time based on the process conditions applied.

Preferably, the reaction time for both steps (A) and (B) is from about 10 minutes to 48 hours.

Advantageously, solution (S1) obtained at the end of step (B) comprises between 5 and 70 wt. % of said salt of formula (I), based on the total weight of the solution.

More preferably, said solution (S1) comprises between 10 and 60 wt. % of said salt of formula (I), for example between 15 and 50 wt. %, between 20 and 40 wt. % or between 25 and 25 wt. %.

Advantageously, said step (B) is performed via molecular sieve or via distillation. More preferably said distillation is performed under reduced pressure or azeotropic distillation. Even more preferably, azeotropic distillation is performed under reduced pressure.

Step (B) can be performed such that only water is removed or water and a part of said solvent(S) are removed at the same time as a mixture [mixture (M2)].

Mixture (M2) can comprise water and the solvent(S) as separate phases or as an homogeneous phase.

Preferably, said mixture (M2) is an azeotrope and said step (B) is performed by azeotropic distillation.

According to a preferred embodiment, the method according to the present invention comprises:
step (A-i) of providing at least one aprotic organic solvent [solvent (S)] and at least one alkali metal compound [compound (AM)];
step (A-ii) of removing any water via azeotropic distillation;
step (A-iii) of adding hydrogen bis(fluorosulfonyl)imide [HFSI] so as to provide said mixture (M1) and
step (B) of removing any water present in said mixture (M1), so as to provide said solution (S1);
wherein steps (A-iii) and (B) are performed simultaneously

Optionally, after said step (B), at least one step (C) of removing any impurity and/or compound (AM) from solution (S1) can be performed.

Such optional step (C) can be performed by any method known in the art, such as filtration.

Optionally, after said step (B), a step (D) of adding an additional amount of said solvent(S) can be performed.

Advantageously, said part of said solvent(S) is recovered from said mixture (M2) and re-used for example in the method of the present invention, so that the total consumption of solvent is reduced.

Hence, according to this embodiment, the method of the present invention comprises, after step (B), a step (E) of recovering at least a part of the solvent(S) from the mixture (M2). Advantageously, after said step (E), a step (F) of supplying the solvent(S) to the mixture (M1) is performed.

Preferably, step (E) and optionally step (F) are performed simultaneously. In addition, step (E) and optional step (F) are performed at the same time as steps (A) and (B).

Said step (E) can be performed by methods known in the art, such as for example by drying. More preferably, said drying is performed via molecular sieves or via pressure-swing distillation if an azeotrope mixture is provided.

The order for performing the optional steps (C), (D), (E) and/or (F) after step (B) is not limited.

The reaction vessel is preferably made of a resin, more preferably of a fluororesin or a polyethylene resin.

The method of the present invention may be carried out in a batch mode or in a continuous or semi-continuous mode.

According to a preferred embodiment, the present invention relates to a method for the manufacture of a solution [solution (S1\hat{ })] comprising at least one organic aprotic solvent and lithium bis(fluorosulfonyl)imide (LiFSI), said method comprising the steps of:
(A\hat{ }) contacting HFSI, at least one aprotic organic solvent [solvent(S)] and at least one lithium compound [compound (AM-L)], so as to provide a reaction mixture, and
(B\hat{ }) removing any water present in said reaction mixture, so as to provide said solution (S1\hat{ }),
   wherein steps (A) and (B) are performed simultaneously.

Preferably, said compound (AM-L) is selected from the group comprising, more preferably consisting of: LiOH, LIOH H₂O, Li₂CO₃, LiHCO₃. More preferably, said compound (AM-L) is selected from the group consisting of LiOH·H₂O and Li₂CO₃.

All the process conditions described above for step (A) and/or step (B), fully apply to step (A\hat{ }) and/or step (B\hat{ }), respectively.

Advantageously, solution (S1) and solution (S1\hat{ }) obtained according to the present invention contain less than 100 ppm of water, preferably less than 50 ppm water, and even preferably below 20 ppm water, as measured by Karl-Fischer analysis.

A further object of the present invention relates to a solution (S1) as defined above, said solution containing at least one salt of formula (I), at least one solvent(S) as defined above and less than 100 ppm of water as measured by Karl-Fischer analysis.

According to a preferred embodiment, the at least one salt of formula (I) is lithium salt of bis(fluorosulfonyl)imide (LiFSI).

A further object of the present invention relates to a solution (S1\hat{ }) as defined above, said solution containing at least one salt of formula (I), at least one solvent (S) as defined above and less than 100 ppm of water as measured by Karl-Fischer analysis.

Advantageously, said LiFSI salt in solution (S1) or in solution (S1\hat{ }) exhibits at least one of the following:
a chloride (Cl⁻) content of below 10,000 ppm, preferably below 5,000 ppm, more preferably below 1,000 ppm, more preferably below 500 ppm, more preferably below 100 ppm, more preferably below 50 ppm, more preferably below 20 ppm, more preferably below 2 ppm; and/or
a fluoride (F⁻) content of below 10,000 ppm, preferably below 5,000 ppm, more preferably below 1,000 ppm, more preferably below 500 ppm, more preferably below 100 ppm, more preferably below 50 ppm, more preferably below 20 ppm; and/or.
a sulfate (SO₄²⁻) content of below 30,000 ppm, preferably below 10,000 ppm, more preferably below 5,000 ppm, more preferably below 2 ppm; and/or
an iron (Fe) content of below 1,000 ppm, preferably below 800 ppm, more preferably below 500 ppm, more preferably below 1 ppm; and/or
a chromium (Cr) content of below 1,000 ppm, preferably below 800 ppm, more preferably below 500 ppm, more preferably below 1 ppm; and/or
a nickel (Ni) content of below 1,000 ppm, preferably below 800 ppm, more preferably below 500 ppm, more preferably below 1 ppm; and/or
a zinc (Zn) content of below 1,000 ppm, preferably below 100 ppm, more preferably below 10 ppm, more preferably below 1 ppm; and/or
a copper (Cu) content of below 1,000 ppm, preferably below 100 ppm, more preferably below 10 ppm, more preferably below 1 ppm; and/or
a bismuth (Bi) content of below 1,000 ppm, preferably below 100 ppm, more preferably below 10 ppm, more preferably below 1 ppm; and/or
a sodium (Na+) content of below 10,000 ppm, preferably below 5 000 ppm, more preferably below 500 ppm, more preferably below 1 ppm and/or
a potassium (K⁺) content of below 10,000 ppm, preferably below 5 000 ppm, more preferably below 500 ppm, more preferably below 1 ppm.

A further object of the present invention is the use of said solution (S1) or of said solution (S1\hat{ }) in a non-aqueous battery electrolyte solution.

Alternatively, if required by the final use or other circumstances, solid LiFSi can be obtained by properly processing said solution (S1) or (S1\hat{ }).

Preferably, said processing is performed via known methods, such as concentration, precipitation, washing and drying.

Should the disclosure of any patents, patent applications, and publications which are incorporated herein by reference conflict with the description of the present application to the extent that it may render a term unclear, the present description shall take precedence.

The disclosure will be now described in more detail with reference to the following examples, whose purpose is merely illustrative and not intended to limit the scope of the disclosure.

### EXPERIMENTAL SECTION

### Example 1—Preparation of LiFSI Solution

A three-necked PTFE round bottom flask equipped with a mechanical stirring, a thermostated bath, a temperature probe, a liquid injection inlet, a packed PTFE column, a condenser and a vacuum pump was placed inside a glovebag, fed with dry nitrogen flow.

The flask is loaded with ethyl methyl carbonate (EMC) and LiOH·H₂O (LiOH:HFSI 1.2:1 mol). The temperature setpoint of the condenser is set at 0° C., and the reaction medium at 10° C. The pressure is then progressively decreased until distillation was observed.

Then, HFSI is added to the reaction mixture over 1 hour. If distillation is discontinued, the pressure is lowered to maintain the distillation flow. The LiFSI concentration in the mixture at the end of the 1 hour addition is in the range 20-40 wt %.

The setup is then put at atmospheric pressure and the crude is filtered on a 0.22 micron PTFE membrane obtaining a filtrate of EMC containing LiFSI, which is analyzed by the following techniques:
ion chromatography to determine anionic impurities, notably coming from FSI hydrolysis (in particular, NH₂FSO₃, FSO₃⁻, SO₄²⁻, F⁻).
¹H-NMR & gas chromatography to evaluate the formation of alcohols from EMC hydrolysis (in particular, ethanol and methanol);
Karl-Fischer method to quantify the water concentration.

1. A method for manufacturing a solution [solution (S1)] comprising at least one organic aprotic solvent and at least one bis(fluorosulfonyl)imide salt represented by the following formula (I): 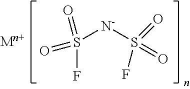
wherein
Mⁿ⁺ represents a metal cation and
n is an integer from 1 to 4;
said method comprising the following steps:
(A) contacting hydrogen bis(flurosulfonyl)imide (HFSI), at least one aprotic organic solvent [solvent(S)] and at least one alkali metal compound [compound (AM)], so as to provide a reaction mixture, and
(B) removing any water present in said reaction mixture via molecular sieve or via distillation, thus providing said solution (S1);
wherein steps (A) and (B) are performed simultaneously.

2. The method according to claim 1, wherein metal cation Mⁿ⁺ is an alkali metal cation selected from Na, Li, K, Rb, and Cs.

3. The method according to claim 1, wherein compound (AM) is selected from the group consisting of: LiOH, NaOH, KOH, RbOH, CsOH, LiOH·H₂O, NaOH·H₂O, KOH·H₂O, RbOH·H₂O, CSOH·H₂O, Li₂CO₃, Na₂CO₃, K₂CO₃, Rb₂CO₃, Cs₂CO₃, LiHCO₃, NaHCO₃, KHCO₃, RbHCO₃ and CsHCO₃.

4. The method according to claim 1, wherein the amount of said compound (AM) is from 1 mol to 10 mol, per 1 mol of HFSI.

5. The method according to claim 1, wherein said solvent (S) is comprising ethylene carbonate, propylene carbonate, butylene carbonate, γ-butyrolactone, γ-valerolactone, dimethoxymethane, 1,2-dimethoxyethane, tetrahydrofuran, 2-methyltetrahydrofuran, 1,3-dioxane, 4-methyl-1,3-dioxolane, methyl formate, methyl acetate, methyl propionate, dimethyl carbonate, ethyl methyl carbonate, diethyl carbonate, sulfolane, 3-methylsulfolane, dimethylsulfoxide, N,N-dimethylformamide, N-methyl oxazolidinone, acetonitrile, valeronitrile, benzonitrile, ethyl acetate, isopropyl acetate, n-butyl acetate, nitromethane and nitrobenzene.

6. The method according to claim 1,
wherein each of step (A) and step (B) are performed:
at a temperature from −10° C. to 40° C.; and/or
at a pressure from 1 mbar to 1 bar.

7. The method according to claim 1, wherein said solution (S1) comprises between 5 and 70 wt. % of said salt of formula (I), based on the total weight of the solution.

8. The method according to claim 1, wherein:
in formula (I), Mⁿ⁺ is Li⁺ and n is 1, and
said at least one compound (AM) is a lithium compound [compound (AM-L)], selected from the group consisting of: LiOH, LIOH·H₂O, Li₂CO₃, LiHCO₃.

9. The method according to claim 1, wherein under step (B) water and at least a part of said solvent(S) are removed at the same time as a mixture [mixture (M2)].

10. The method according to claim 9, wherein said mixture (M2) is an azeotrope and step (B) is performed via azeotropic distillation.

11. The method according to claim 1, said method comprising:
step (A-i) of providing at least one aprotic organic solvent [solvent(S)] and at least one alkali metal compound [compound (AM)];
step (A-ii) of removing any water via azeotropic distillation;
step (A-iii) of adding hydrogen bis(fluorosulfonyl)imide [HFSI] so as to provide said mixture (M1) and
step (B) of removing any water present in said mixture (M1), so as to provide said solution (S1);
wherein steps (A-iii) and (B) are performed simultaneously.

12. The method according to claim 1, said method comprising after step (B):
at least one step (C) of removing any impurity and/or compound (AM) from solution (S1); and/or
a step (D) of adding an additional amount of said solvent (S); and/or
a step (E) of recovering at least a part of the solvent (S) from said mixture (M2), optionally followed by a step (F) of supplying said recovered solvent (S) to the mixture (M1).

13. A solution (S1) comprising at least one organic aprotic solvent, at least one bis(fluorosulfonyl)imide salt represented by the following formula (I): 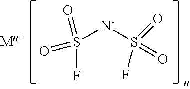
wherein
Mⁿ⁺ represents a metal cation and
n is an integer from 1 to 4;
and less than 100 ppm of water, as measured by Karl-Fischer analysis.

14. A solution (S1), which is obtained by the method according to claim 1 wherein the solution comprises:
at least one organic aprotic solvent, at least one bis(fluorosulfonyl)imide salt represented by the following formula (I): 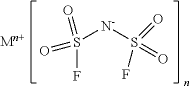
wherein
Mn+ represents a metal cation and
n is an integer from 1 to 4; and
less than 100 ppm of water, as measured by Karl-Fischer analysis.

15. A method comprising providing the solution (S1) according to claim 13 in a non-aqueous battery electrolyte.
